(19) United States
(12) Patent Application Publication
(10) Pub. No.: US 2026/0253006 A1
(43) Pub. Date: Aug. 27, 2026

(54) EXCESS POWER CONSUMPTION PREDICTION SYSTEM

(71) Applicant: ENlighten Co., Ltd., Seoul (Songpa-gu) (KR)

(72) Inventors: Dong Woo LEE, Seoul (KR); Jae Min PARK, Seoul (KR)

(21) Appl. No.: 19/551,185

(22) Filed: Feb. 26, 2026

(30) Foreign Application Priority Data
Feb. 26, 2025 (KR) 10-2025-0025229

(51) Int. Cl. G06Q 10/0633; G06N 3/0464

(52) U.S. Cl. CPC G06Q 10/06334; G06N 3/0464

(57) ABSTRACT

The present invention relates to an excess power consumption prediction system that collects power consumption, power generation, and weather information of a factory, predicts a power excess state in which the consumption exceeds the generation, analysis causes using operation information and correction information, and generates a response strategy.

### RELATED APPLICATIONS

The present application claims the priority benefit of Korean Pat. App. No. 10-2025-0025229, filed on Feb. 26, 2025 (DAS code: 1C81), to Enlighten Co., Ltd., the contents of which are fully incorporated by reference herein in their entirety.

### TECHNICAL FIELD

The present invention relates to a system for predicting excess power consumption, and more particularly, to a power management system that collects power consumption and generation data, analyzes the possibility of excess power consumption using a machine learning-based prediction model, establishes an optimal response strategy, and delivers the strategy to an administrator.

### BACKGROUND

The importance of power management is increasing in modern industrial facilities and factories. As the scale of industrial facilities expands and automation progresses, power consumption continues to increase, and accordingly, efficient power operation is acting as a key factor in cost reduction and maintaining productivity of companies.

In addition, from the perspective of energy policy that must consider power grid stability and sustainability, optimizing the power consumption patterns of large-scale factories is becoming an essential task.

In particular, as the proportion of renewable energy increases, the imbalance between power generation and power consumption is emerging as a new problem. The intermittent characteristics of solar and wind power generation make it difficult for existing power management systems to effectively adjust supply and demand in real time.

When weather deteriorates or the efficiency of solar panels decreases, the expected power generation drops sharply, which causes the factory to consume more power than expected power generation, and this may lead to instability in power grid operation.

Current power management systems provide power consumption monitoring and limited predictive functions, but lack the ability to detect and respond to excess power consumption in advance.

Most systems are limited to methods that perform simple demand prediction based on historical data or send warnings when power consumption above a certain level is detected.

However, such methods have a limitation of being able to respond only after power excess occurs, and without proactive measures, it becomes difficult to adjust production schedules, and operating costs may increase due to unnecessary additional power purchases.

Accordingly, a system is required that may monitor power consumption of a factory and solar power generation in real time and may predict the possibility of power excess in advance based on weather changes and factory operation patterns.

In addition, beyond simple prediction, there is a growing need to analyze the cause of power excess, automatically generate optimal response strategies, and provide them to an administrator.

Such technology has been disclosed in Korean Patent Registration No. 102227192 and Korean Patent Registration No. 102427294.

### SUMMARY

The present invention was conceived based on the above technical background, and the present invention provides an excess power consumption prediction system that predicts in advance a power excess state in which the power consumption occurring in a factory exceeds the power generation, analyzes the main cause of power excess by utilizing various operation information, power generation information, weather information, and correction information, thereby automatically establishing an optimal response strategy and delivering the strategy in real time to efficiently manage power consumption and ensure stable power consumption, and to maximize energy cost savings and operational efficiency of the factory.

In order to achieve the above object, the excess power consumption prediction system of the present invention includes a database; a data acquisition unit configured to collect consumption information representing power consumption occurring in a factory, power generation information representing power generation produced by a generator, and weather information, and to store them in the database; and a controller configured to predict whether a power excess state in which the consumption information exceeds the power generation information occurs through information stored in the database.

In addition, the controller may include a data processing unit configured to receive a plurality of pieces of information stored in the database, remove outliers, normalize the information, and generate preprocessing information in a form suitable for analysis by the machine learning model.

In addition, the controller may further include a prediction analysis unit configured to rapidly generate a prediction result as to whether the power excess state occurs through a machine learning model that learns an extracted portion of the plurality of pieces of information stored in the database.

In addition, the machine learning model may include a CNN (Convolutional Neural Network) model, learn by converting a plurality of pieces of information including consumption information, power generation information, and weather information into a two-dimensional form, and generate the prediction result by analyzing patterns along a time axis.

In addition, the prediction analysis unit may include a prediction correction unit that includes a verification model for verifying the prediction result generated by the machine learning model and is configured to generate a plurality of comparison values using the verification model and determine reliability of the prediction result.

In addition, the prediction correction unit may generate a plurality of correction values by changing information used by the machine learning model if the reliability of the prediction result is determined to be low, and determine again whether the power excess state occurs using the average of the plurality of correction values generated.

In addition, the controller may further include a response strategy establishment unit configured to analyze the causes of occurrence of the power excess state and establish a response strategy.

In addition, the data acquisition unit may be configured to additionally acquire operation information about a process operation rate of the factory and an operating state of equipment and correction information including a number of employees who have come to work and a cleaning state of the generator, and the controller may be configured to pattern the power generation information according to the operation information and the correction information to predict the power excess state..

According to an embodiment of the present invention, the excess power consumption prediction system may systematically manage power consumption patterns of a factory and predict the possibility of occurrence of power excess in advance, thereby enhancing stability of energy use and optimizing operation.

According to an embodiment of the present invention, the excess power consumption prediction system may support a machine learning model to learn more refined data, thereby improving prediction accuracy and providing highly reliable analysis results.

According to an embodiment of the present invention, the excess power consumption prediction system may enable more effective learning a relationship between power consumption patterns and weather changes, and convert time-series data into a two-dimensional structure to enhance precision of prediction and implement a machine learning model capable of real-time analysis.

According to an embodiment of the present invention, the excess power consumption prediction system may evaluate the reliability of the prediction result, and when the reliability is low, generate a correction value to improve the final prediction result, thereby enabling reliable power prediction is possible.

According to an embodiment of the present invention, the excess power consumption prediction system may establish a response strategy, thereby maximizing efficiency of energy management and minimizing unnecessary power waste.

### BRIEF DESCRIPTION OF THE DRAWINGS

FIG. 1 is a block diagram of an excess power consumption prediction system according to an embodiment of the present invention.

FIG. 2 is an operation diagram of a data acquisition unit according to an embodiment of the present invention.

FIG. 3 is a block diagram of a controller according to an embodiment of the present invention.

FIG. 4 is an operation diagram of a data processing unit according to an embodiment of the present invention.

FIG. 5 is an operation diagram of a prediction analysis unit according to an embodiment of the present invention.

FIG. 6 is a diagram illustrating a form of preprocessed information according to an embodiment of the present invention.

FIG. 7 is an operation diagram of a short-term analysis unit according to an embodiment of the present invention.

FIG. 8 is an operation diagram of a prediction correction unit according to an embodiment of the present invention.

FIG. 9 is an operation diagram of a response strategy establishment unit and an information delivery unit according to an embodiment of the present invention.

### DETAILED DESCRIPTION OF EMBODIMENTS

Hereinafter, preferred embodiments according to the present invention will be described in detail with reference to the accompanying drawings.

Advantages and features of the present invention, and methods of achieving them will become clear with reference to the embodiments described below in detail together with the accompanying drawings.

However, the present invention is not limited by the embodiments disclosed below, but will be implemented in various different forms, and the present embodiments are merely provided to make the disclosure of the present invention complete and to completely inform those of ordinary skill in the art to which the present invention pertains of the scope of the invention, and the present invention is only defined by the scope of the claims.

In addition, in describing the present invention, if it is determined that a detailed description of related known technologies may obscure the gist of the present invention, the detailed description thereof will be omitted.

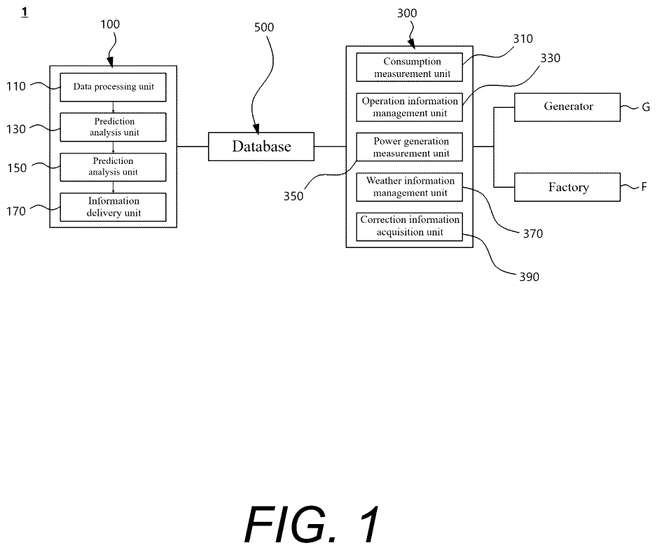

FIG. 1 is a block diagram of an excess power consumption prediction system according to an embodiment of the present invention.

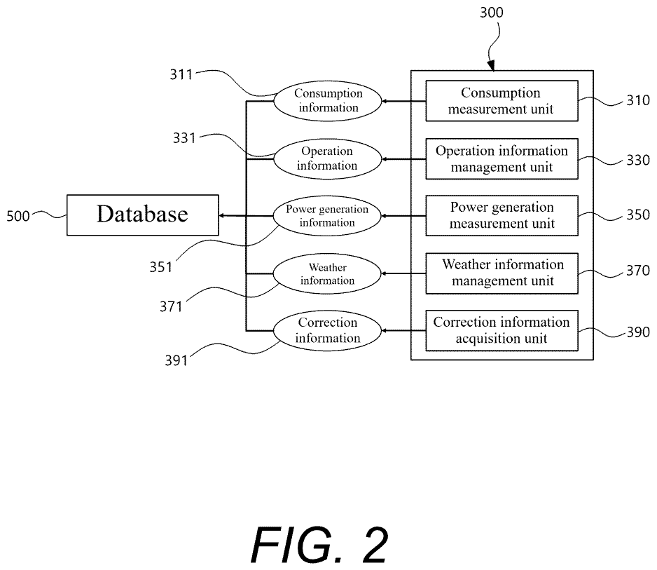

FIG. 2 is an operation diagram of a data acquisition unit according to an embodiment of the present invention.

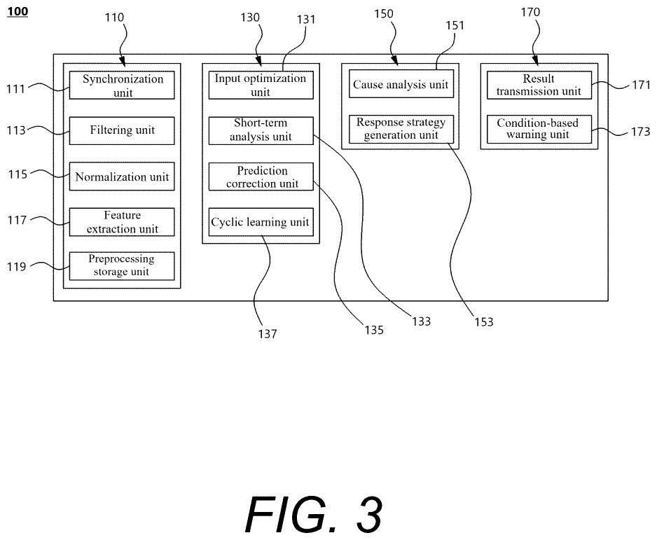

FIG. 3 is a block diagram of a controller according to an embodiment of the present invention.

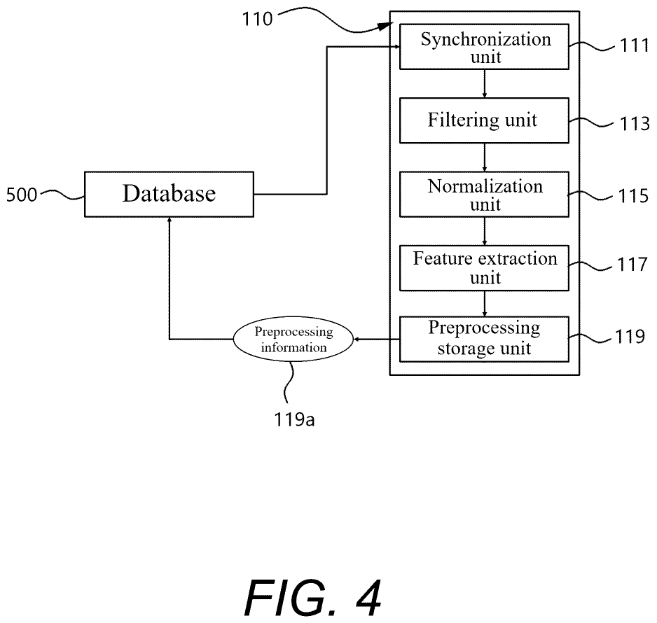

FIG. 4 is an operation diagram of a data processing unit according to an embodiment of the present invention.

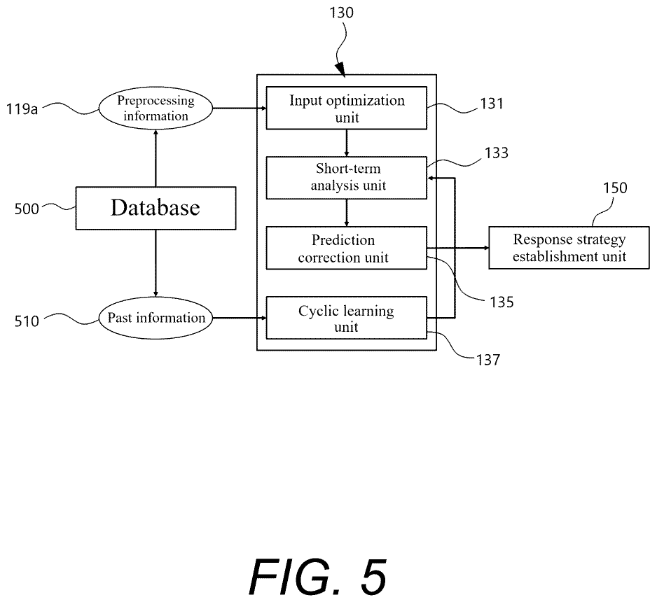

FIG. 5 is an operation diagram of a prediction analysis unit according to an embodiment of the present invention.

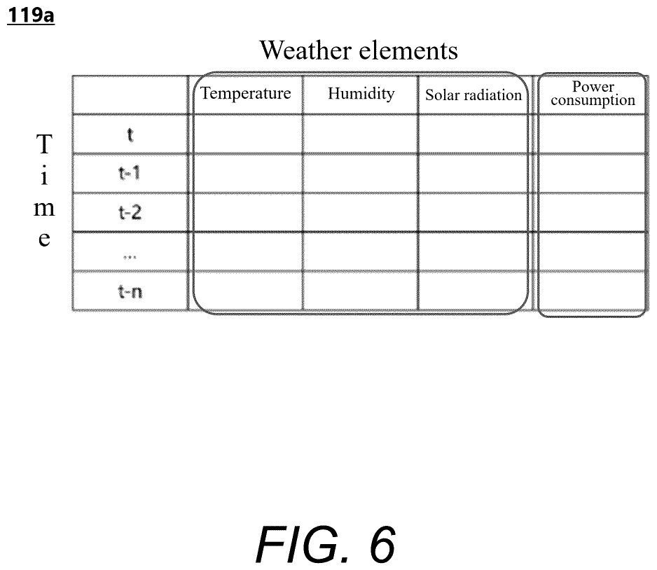

FIG. 6 is a diagram illustrating a form of preprocessed information according to an embodiment of the present invention.

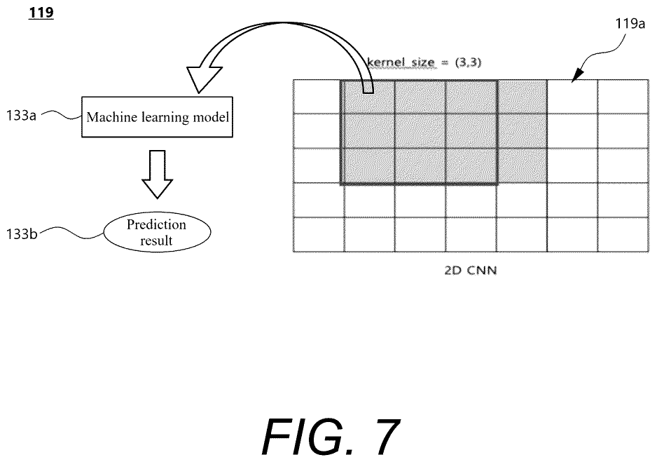

FIG. 7 is an operation diagram of a short-term analysis unit according to an embodiment of the present invention.

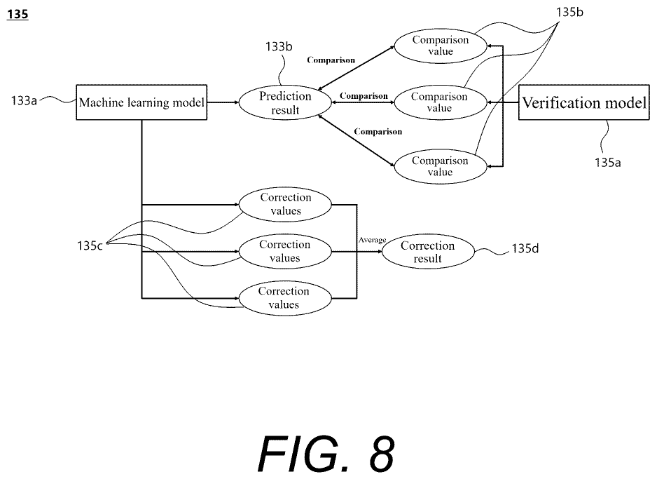

FIG. 8 is an operation diagram of a prediction correction unit according to an embodiment of the present invention.

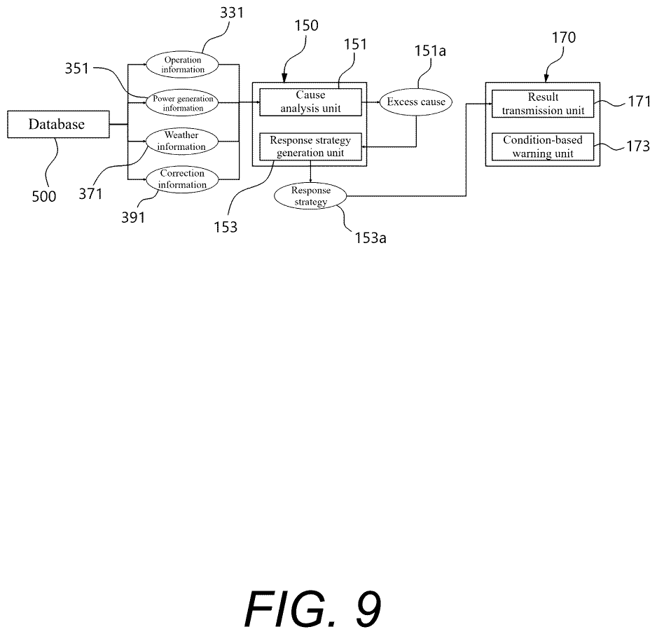

FIG. 9 is an operation diagram of a response strategy establishment unit and an information delivery unit according to an embodiment of the present invention.

Referring to FIG. 1, an excess power consumption prediction system 1 includes a data acquisition unit 300, a controller 100, and a database 500. The data acquisition unit 300 serves to collect data obtained from a factory F and a generator G, and it includes a consumption measurement unit 310, an operation information management unit 330, a power generation measurement unit 350, a weather information management unit 370, and a correction information acquisition unit 390.

The consumption measurement unit 310 measures power consumption of the factory F to generate consumption information 311, and the operation information management unit 330 acquires operation information 331 including a process operation rate of the factory and an operating state of equipment.

The power generation measurement unit 350 measures the power generated by the generator G to generate power generation information 351, and the weather information management unit 370 acquires weather information 371 including temperature, humidity, solar radiation, and the like.

In addition, the correction information acquisition unit 390 additionally acquires correction information 391 including a number of employees who have come to work, a cleaning state of the generator, and the like, to support more precise prediction.

The consumption information 311, operation information 331, power generation information 351, weather information 371, and correction information 391 acquired by the data acquisition unit 300 are stored in the database 500.

The database 500 stores all information delivered from the data acquisition unit 300, and provides it to the controller 100 for analysis.

The controller 100 includes a data processing unit 110, a prediction analysis unit 130, a response strategy establishment unit 150, and an information delivery unit 170.

The data processing unit 110 serves to process data collected by the data acquisition unit 300 into a form suitable for analysis, and includes a synchronization unit 111, a filtering unit 113, a normalization unit 115, a feature extraction unit 117, and a preprocessing storage unit 119.

The synchronization unit 111 temporally synchronizes collected data, the filtering unit 113 removes outliers, and the normalization unit 115 converts data into a certain range.

The feature extraction unit 117 generates key features to enable effective learning of a machine learning model 133a, and the preprocessing storage unit 119 stores preprocessed information 119a in a form suitable for analysis by the machine learning model 133a for use in subsequent analysis.

The prediction analysis unit 130 includes an input optimization unit 131, a short-term analysis unit 133, a prediction correction unit 135, and a cyclic learning unit 137, and it predicts a power excess state using the machine learning model 133a.

The input optimization unit 131 selects optimal input data for the machine learning model 133a to learn, and the short-term analysis unit 133 analyzes data to generate a prediction result 133b.

The prediction correction unit 135 evaluates reliability of the prediction result 133b using a verification model 135a, and generates comparison values 135b and correction values 135c to derive a correction result 135d.

In this case, the verification model 135a may include ARIMA (AutoRegressive Integrated Moving Average), which predicts a future value by learning past patterns based on time-series data, SARIMA (Seasonal ARIMA), an exponential smoothing method, which assigns weights to recent data for prediction, LSTM (Long Short-Term Memory), which is a recurrent neural network model that learns long-term patterns of time-series data, and an Autoencoder that evaluates reliability by learning normal power consumption patterns and analyzing differences from prediction result.

The cyclic learning unit 137 continuously improves performance of the machine learning model 133a by reflecting corrected data.

The response strategy establishment unit 150, which is composed of a cause analysis unit 151 and a response strategy generation unit 153, analyzes the cause of occurrence of power excess and derives an optimal response strategy 153a accordingly.

The response strategy may include measures such as load adjustment of the factory F, utilization of an ESS (energy storage system), purchase of external power, and the like.

The information delivery unit 170includes a result transmission unit 171 and a condition-based warning unit 173, and serves to deliver information generated by the prediction analysis unit 130 and the response strategy establishment unit 150 to the administrator.

The result transmission unit 171 provides the prediction result and the response strategy, and the condition-based warning unit 173 may notify the administrator when a specific condition preset by the administrator is satisfied.

As described above, the excess power consumption prediction system 1 of the present invention stores various pieces of information collected by the data acquisition unit 300 in the database 500.

Through the data processing unit 110, the prediction analysis unit 130, the response strategy establishment unit 150, and the information delivery unit 170 of the controller 100, the power excess state may be effectively predicted and a response strategy may be established, thereby optimizing power consumption of the factory.

Referring to FIG. 2, the data acquisition unit 300 includes a consumption measurement unit 310, an operation information management unit 330, a power generation measurement unit 350, a weather information management unit 370, and a correction information acquisition unit 390, and each component collects data through respective sensors and systems.

The consumption measurement unit 310 serves to measure power consumption of the factory, and may include a power meter, a smart meter, a current sensor, and the like.

The consumption information 311 acquired by the consumption measurement unit 310 includes real-time power consumption, voltage, current, power factor, and peak load data of the entire factory and individual equipment.

Such information may serve as a criterion for identifying power consumption patterns, predicting peak loads, and defining a power excess state. In addition, energy management may be optimized by detecting whether specific equipment is overloaded in real time.

The operation information management unit 330 collects information related to factory operation, and may include a PLC (Programmable Logic Controller), a SCADA (Supervisory Control and Data Acquisition) system, a temperature and humidity sensor, and the like.

The operation information 331 acquired by the operation information management unit 330 includes a process operation rate, a production schedule, an equipment operating state, a maintenance history, and internal factory environment data.

The operation information 331 may be used to predict power consumption in a specific process, and may be used to generate the response strategy 153a.

Based on the operation information 331, production schedules may be adjusted to reduce unnecessary power consumption. In addition, based on the maintenance history, energy efficiency of equipment may be predicted to improve long-term energy efficiency.

The power generation measurement unit 350 serves to monitor a power generation of a solar generator G used in the factory, and may include an inverter, a power generation measurement sensor, and a solar panel monitoring system.

The power generation information 351 acquired by the power generation measurement unit 350 includes solar power generation, solar panel efficiency, generator output voltage, and an ESS (energy storage system) charge state.

The power generation information 351 is used not only for learning of the machine learning model 133a, but also allows real-time power generation to be monitored and compared with power consumption, and enables immediate action to be taken when solar power generation efficiency decreases.

In addition, energy storage and discharge strategies may be optimized by identifying the ESS charge state.

The weather information management unit 370 serves to measure weather conditions outside the factory, and may include a temperature sensor, a humidity sensor, a wind speed sensor, an atmospheric pressure sensor, and a solar radiation measurement sensor.

The weather information 371 acquired by the weather information management unit 370 includes temperature, humidity, solar radiation, wind speed, atmospheric pressure, precipitation, and an air pollution level.

The weather information 371 is essential for solar power generation prediction, and may reflect patterns of increased power consumption under specific weather conditions, and enables more precise prediction by considering that power generation may be impeded under certain weather conditions.

For example, at high temperature, power consumption of a cooling system may increase, or in strong wind, power generation efficiency of solar panels may change, requiring correction.

The correction information acquisition unit 390 collects additional information for increasing accuracy of power consumption and power generation, and may include an access control system, an equipment diagnosis sensor, a pollution degree measurement sensor, and the like.

The correction information 391 acquired by the correction information acquisition unit 390 includes the number of employees at work, a contamination state of solar panels, a maintenance schedule of the generator, and an operating temperature of equipment.

Although the correction information 391 does not directly measure power consumption of the factory F, it helps to improve accuracy of a prediction model by analyzing a correlation between factors that may affect power consumption.

For example, when the number of employees at work increases, the likelihood of increased power consumption is high, and when the probability of solar panel contamination increases, power generation may decrease, allowing the machine learning model 133a to operate more precisely by considering these factors.

Referring to FIG. 3, the controller 100 includes a data processing unit 110, a prediction analysis unit 130, a response strategy establishment unit 150, and an information delivery unit 170, and each component serves to perform power consumption prediction and response strategy establishment.

The data processing unit 110 serves to process collected data into a form suitable for analysis. The synchronization unit 111 creates a data set showing how much value is measured per hour by unifying and aligning time units of data collected from various sensors and data sources.

The filtering unit 113 detects and removes outliers in data to prevent errors in a learning and analysis process of the model.

The normalization unit 115 converts collected data into uniform units, corrects values measured in mutually different units into the same unit, and enables the machine learning model 133a to effectively process various data formats.

The feature extraction unit 117 derives main feature values for the machine learning model 133a to perform analysis efficiently, thereby improving performance of prediction

### Analysis.

The preprocessing storage unit 119 stores and manages preprocessed preprocessing information 119a to be utilized in subsequent analysis. The data processing unit 110 is a component for increasing accuracy of the entire system.

The prediction analysis unit 130 serves to predict whether a power excess state in which power to be produced by the generator G exceeds power required by the factory F will occur.

The input optimization unit 131 may select optimal information for the machine learning model to learn among a large number of pieces of information belonging to the preprocessing information 119a, in which a state of the factory F and a state of the generator G are similar to those in past cases. Through this, a computation cost due to unnecessary information is reduced.

The short-term analysis unit 133 serves to predict a change in power consumption within a specific time using a machine learning model 133a such as a CNN (Convolutional neural network).

The prediction correction unit 135 generates comparison values 135b using a plurality of verification models 135a to verify the prediction result 133b of the short-term analysis unit 133 and evaluates reliability. If the reliability is low, a correction value 135c is derived to modify the prediction result 133b.

The cyclic learning unit 137 serves to enhance the performance of the machine learning model 133a by continuously reflecting the prediction result 133b and the correction result 135d. The prediction analysis unit 130 enables grasping the possibility of occurrence of a power excess state in advance and responding thereto.

The response strategy establishment unit 150 serves to establish an optimal response strategy when power excess occurs. The cause analysis unit 151 analyzes a cause of occurrence of power excess, and identifies an excess cause 151a by considering an operating state of the factory and an external environmental factor.

The response strategy generation unit 153 generates an optimal response strategy such as power load adjustment, ESS (energy storage system) utilization, external power purchase, and the like based on the excess cause 151a derived from the cause analysis unit 151.

The information delivery unit 170 serves to deliver a prediction result and a response strategy to an administrator. The result transmission unit 171 provides a predicted power consumption and a possible power excess state to the administrator, and enables the administrator to take action based this.

The condition-based warning unit 173 sends a warning to the administrator in real time when a specific condition occurs, thereby enabling a rapid response.

In this case, the specific condition may be a situation in which a power load exceeding a set threshold value occurs, a situation in which an operating time of specific equipment continues for a preset time or longer, and a situation in which a temperature of the generator rises above a preset temperature requiring thermal management.

The information delivery unit 170 serves to effectively deliver results of the system to an administrator to support prediction and response strategies to be actually executed.

The controller 100 operates in a manner of refining data through the data processing unit 110, predicting the possibility of power excess by utilizing the prediction analysis unit 130, deriving an appropriate response strategy through the response strategy establishment unit 150, and then delivering results to the administrator by using the information delivery unit 170.

Through this, energy use of a factory and a generator may be optimized, prediction accuracy may be increased, and a cost increase due to an increase in power consumption may be prevented.

Referring to FIG. 4, the data processing unit 110 includes a synchronization unit 111, a filtering unit 113, a normalization unit 115, a feature extraction unit 117, and a preprocessing storage unit 119, and each component refines collected data and processes it into a form suitable for analysis.

The synchronization unit 111 temporally aligns data, and when data from various sensors have different collection times, aligns them on the same time axis.

For example, when the consumption measurement unit 310 provides data at 1-minute intervals, whereas the weather information management unit 370 provides data at 1-hour intervals, the synchronization unit 111 generates a consistent data set by aligning them on the same basis.

This enable the machine learning model 133a to learn from consistent data over time.

The filtering unit 113 serves to remove outliers in data. For example, when a certain sensor records abnormally high power consumption due to a temporary error in the factory, the filtering unit 113 detects and removes or modifies the data. This may prevent the machine learning model from being distorted by error data.

In addition, the normalization unit 115 converts data units to enable effective analysis by the model. For example, temperature data may be provided in Celsius, whereas weather forecast data may be provided in Fahrenheit.

In this case, the normalization unit 115 converts into the same unit, and normalizes power consumption data so that it can be processed within a certain range. Through this, the learning speed of the model may be increased and performance may be improved.

The feature extraction unit 117 serves to derive meaningful features from data enabling the machine learning model 133a to learn.

For example, instead of inputting simple power consumption data as is, additional features such as an average consumption during a specific time, a maximum load occurrence time, a peak power consumption pattern, and the like are extracted such that the model may perform more precise predictions.

The preprocessing storage unit 119 stores preprocessed data in the form of preprocessing information 119a in a preset format, and enables the data to be utilized in a subsequent analysis process in conjunction with the database 500.

By storing information stored in the database 500 in a single format of the preset preprocessing information 119a, data from specific past time points can be easily recalled and compared, and long-term analysis is enabled while maintaining data quality.

Referring to FIG. 5, the prediction analysis unit 130 includes an input optimization unit 131, a short-term analysis unit 133, a prediction correction unit 135, and a cyclic learning unit 137.

The input optimization unit 131 serves to select and optimize data necessary for predicting whether power excess occurs.

The preprocessing information 119a and the past information 510 are analyzed to determine essential features that the machine learning model 133a must learn.

For example, if the influence that a specific weather condition has on solar power generation is large, an optimal input data combination is selected to importantly reflect the weather data. Through this, by removing unnecessary data, the analysis speed may be improved and prediction accuracy may be increased.

The short-term analysis unit 133 analyzes a power consumption pattern by utilizing a CNN (Convolutional Neural Network) model and rapidly performs a short-term prediction.

Through the short-term analysis unit 133, factors such as power consumption changing in real time and weather changes may be reflected to predict the possibility of power excess that may occur within a few hours in the future. Through this, a prior response to a power excess state is supported.

The prediction correction unit 135 serves to verify and correct the prediction result 133b generated by the short-term analysis unit 133.

The prediction correction unit 135 evaluates the reliability of the prediction result 133b by using a plurality of verification models 135a, and when the reliability is low, generates a plurality of correction values 135c to derive a more accurate correction result 135d.

For example, if the current CNN model exhibits a large error under a specific weather condition, when generating a correction value 135c, other information except the weather information 371 is used to generate a correction value. Therefore, the reliability of the prediction system may be increased.

The cyclic learning unit 137 serves to continuously train the machine learning model by comparing the prediction result with actual power consumption. When a prediction result is different from reality, the cause is analyzed and learning data is updated such that the model gradually improves.

For example, when power consumption changes according to changes in an operation pattern of a specific factory, the cyclic learning unit 137 reflects this to update the prediction model. Through this, accuracy of prediction is continuously improved over time.

By utilizing the components of the prediction analysis unit 130 as described above, real-time data and past data may be comprehensively analyzed to more precisely predict whether power excess occurs.

In addition, the performance of the prediction model may be continuously improved through correction and learning processes, and this enables power operation optimization of the factory F.

Referring to FIGS. 6 and 7, in the present invention, the preprocessing information 119a refined by the data processing unit 110 is organized in a table format so that the machine learning model 133a may effectively learn.

The preprocessing information 119a includes weather information 371 including weather elements (temperature, humidity, solar radiation) at times (t, t−1, t−2, . . . , t−n), operation information 331 and correction information 391, and power consumption information 311.

Such table-format data is aligned along a time axis, and is recorded at regular time intervals from past data (t−n) to latest data.

This enables the machine learning model 133a to learn the relationship between a power consumption patterns and other weather information 371, operation information 331, and correction information 391 based on time-series data.

The machine learning model 133a of the present invention includes a CNN (Convolutional Neural Network) model, and the CNN model may also be utilized not only to analyze image data but also time-series data by converting it into a two-dimensional matrix form.

The CNN model has an ability to automatically detect important patterns from input data, and learns the correlation between adjacent data by using a specific filter (kernel).

In the present invention, by using the machine learning model 133a as a CNN model, the relationship between power consumption and weather conditions may be learned, and based on this, whether power excess occurs may be predicted.

The reason why table-format information is necessary is that the CNN model receives data in a two-dimensional array form. In other machine learning models (e.g., regression analysis, LSTM, etc.), individual time-series data is learned as is, but the CNN model may spatially interpret data to analyze local patterns.

For example, if there is a pattern in which power consumption increases under specific temperature and humidity conditions, the CNN model may effectively detect it. To this end, the data is converted into a table format including the time axis and data for each weather element, and is optimized so that the CNN model may learn.

The short-term analysis unit 133 analyzes power consumption patterns and performs short-term predictions by utilizing the CNN model. In order for the CNN model to operate effectively, what information should be for learning is very important.

For example, if there is a pattern in which power consumption rapidly increases in a specific season (summer or winter), the CNN model needs to focus on learning the data.

In the present invention, main data that the CNN model should learn is selected through the input optimization unit 131 to increase prediction accuracy and reduce computation costs due to unnecessary data.

One of the features of the CNN model is that it may detect local patterns through kernel operations.

In the present invention, by setting a kernel size to (3, 3), the model may learn the relationship between adjacent data (t−1, t−2, etc.) and weather elements (temperature, humidity, solar radiation, etc.) based on time (t).

Accordingly, a pattern in which power consumption rapidly changes under specific weather conditions may be effectively detected.

When learning the CNN model, some data is selected from the preprocessing information 119a and is used as learning data.

For example, a small subset including weather information and power consumption data for the last 24 hours may be selected for the CNN model to learn. Through this, the computation burden of a learning model may be reduced while more precise predictions may be performed by utilizing only important information.

The performance of the model depends greatly on which data is selected, and if unnecessary data is learned, prediction performance may rather decrease. Therefore, it is important to carefully construct input data and reflect essential features.

After learning the CNN model, a prediction result 133b is finally derived, and this result undergoes verification by the prediction correction unit 135, and when the reliability is low, an additional correction process is performed.

The excess power consumption prediction system 1 of the present invention applies a Feature Engineering technique to generate new features to improve the accuracy of power consumption prediction.

To this end, past consumption information 311, weather information 371, and power generation information 351 of a specific factory F are collected, and a clustering model is applied to utilize them to reflect seasonal patterns according to the weather information 371.

First, weather observation data for the past N years is analyzed and classified into 3 to 4 seasonal clusters, and for example, clusters such as early summer, autumn, winter, and spring may be generated.

Thereafter, based on weather forecast data at time T+1, by utilizing a pre-trained clustering model, which cluster the weather state at the time point belongs to is determine.

Average power consumption and average power generation belonging to the determined cluster are added as new features and utilized as input data of the machine learning model 133a, thus enabling more precise power consumption prediction.

Through this, the relationship between a weather state and power consumption may be more accurately modeled, and prediction accuracy may be maximized by reflecting various seasonal characteristics.

As a result, the prediction system of the present invention may generate a prediction result with high reliability by reflecting real-time changes in power consumption patterns and weather conditions.

Referring to FIG. 8, the prediction correction unit 135 serves to verify the prediction result 133b of the machine learning model 133a, and when the reliability is low, generate a correction value 135c to derive a final correction result 135d.

First, the machine learning model 133a predicts whether power excess occurs to generate a prediction result 133b. This prediction result 133b is compared with a plurality of comparison values 135b by a verification model 135a that may predict whether power excess occurs by a plurality of methods.

The comparison value 135b may include results derived from past patterns, other machine learning models, statistical prediction models, and the like. Through this, the extent to which a current prediction value matches existing data patterns may be evaluated.

The verification model 135a analyzes the difference between the prediction result 133b and the comparison values 135b to determine reliability. If the difference between the prediction result 133 b and the comparison value 135b is large, it is determined that the reliability of the prediction result is low, and a correction process is performed.

In this case, the prediction result 133b may be information about whether excess power consumption will occur or not. In other words, determining how much the numerical shortage is may cause the computation process of the machine learning model 133a to become long, making it difficult to draw a rapid and immediate conclusion.

However, if the prediction result 133b is simply about whether a power excess state will occur, the result may be derived more rapidly.

In this case, the plurality of comparison values 135b also simply determine only whether a power excess state occurs, and when comparison values 135b that predict the same as the prediction result 133b are equal or exceed a preset number, the prediction result 133b is determined to be valid.

In a correction process, a plurality of correction values 135 c are generated. A correction value 135c is a value for correcting the prediction result 133b, and may be generated through retraining of the machine learning model 133a based on other data combinations or by reflecting data patterns in similar situations in the past.

In the machine learning model 133a, a plurality of correction values 135c are generated, each representing a modified prediction value for supplementing the existing prediction.

Finally, the average of the plurality of correction values 135c generated is calculated to derive the correction result 135d. The correction result 135d may be different from the prediction result 133b that the machine learning model 133a first predicted, but may be the same.

The configuration of the prediction correction unit 135 as described above evaluates the prediction reliability of the machine learning model in real time, and, when necessary, automatically performs correction to generate the correction result 135d, thereby improving prediction accuracy.

In addition, the learning model may be gradually improved through a continuous correction process, thereby increasing the reliability of power consumption prediction and reducing errors.

Referring to FIG. 9, when a power excess state is predicted, a process of analyzing the cause thereof and generating an appropriate response strategy to deliver to the administrator is performed.

First, operation information 331, power generation information 351, weather information 371, and correction information 391 stored in the database 500 are provided to the response strategy establishment unit 150.

The response strategy establishment unit 150 includes a cause analysis unit 151 and a response strategy generation unit 153, each of which serves to analyze the cause of the power excess state and establish an optimal response strategy.

The cause analysis unit 151 serves to identify a main cause of power excess state. To this end, based on the operation information 331, it analyzes whether power consumption rapidly increases in a specific process or equipment, and identifies time points at which a solar power generation decreases by utilizing the power generation information 351.

In addition, using the weather information 371, the influence of weather changes on power consumption is evaluated, and by utilizing the correction information 391, additional environmental factors are considered. As a result of the analysis, when a specific cause that induces power excess state is derived, the cause is defined as an excess cause 151a.

Thereafter, the response strategy generation unit 153 derives an appropriate response strategy 153a according to the excess cause 151a.

The response strategy 153a includes a power load adjustment strategy for adjusting power consumption of a specific process to mitigate a peak load, an energy storage system (ESS) utilization strategy for discharging stored energy during an excess power consumption time period by utilizing an ESS battery, a power purchase optimization strategy for securing additional power by utilizing the power utility and an external power supply network, and a factory operation optimization strategy for adjusting a process schedule to reduce power consumption at a specific time period.

The derived response strategy 153a is delivered to the information delivery unit 170, and the information delivery unit 170 includes a result transmission unit 171 and a condition-based warning unit 173. The result transmission unit 171 serves to provide an analyzed prediction result and a response strategy to an administrator.

For example, when a power excess state is expected, the corresponding time point and the cause are explained in detail, and an appropriate response strategy is delivered to the administrator. Through this, the administrator may take appropriate actions.

The condition-based warning unit 173 generates a warning in real time when a specific condition is satisfied. For example, when a power excess state above a specific threshold is expected or when the remaining ESS battery charge level is insufficient, a notification is automatically provided to the administrator to prompt an immediate response.

In addition, even when solar panel contamination is severe, reducing power generation, a warning may be generated to inform the administrator that maintenance is necessary.

The operation method of the response strategy establishment unit 150 and the information delivery unit 170 as described above contributes to maximizing energy efficiency of the factory by predicting a power excess state in advance and providing an optimal response plan.

In addition, through a real-time warning system, an immediate response is supported when an emergency situation occurs, thereby enabling power consumption optimization to be realized.

The present invention has been described with reference to the embodiment(s) illustrated in the drawings, but this is merely exemplary, and those of ordinary skill in the art will understand that various modifications may be made therefrom, and all or unit of the embodiment(s) described above may be selectively combined and configured. Therefore, the true technical protection scope of the present invention should be determined by the technical spirit of the appended claims.

### DESCRIPTION OF REFERENCE NUMERALS

1: Prediction system
100: Controller
110: Data processing unit
111: Synchronization unit
113: Filtering unit
115: Normalization unit
117: Feature extraction unit
119: Preprocessing storage unit
119a: Preprocessing information
130: Prediction analysis unit
131: Input optimization unit
133: Short-term analysis unit
133a: Machine learning model
133b: Prediction result
135: Prediction correction unit
135a: Verification model
135b: Comparison value
135c: Correction value
135d: Correction result
137: Cyclic learning unit
150: Response strategy establishment unit
151: Cause analysis unit
151a: Excess cause
153: Response strategy generation unit
153a: Response strategy
170: Information transmission unit
171: Result transmission unit
173: Condition-based warning unit
300: Data acquisition unit
310: Consumption measurement unit
311: Consumption information
330: Operation information management unit
331: Operation information
350: Power generation measurement unit
351: Power generation information
370: Weather information management unit
371: Weather information
390: Correction information acquisition unit
391: Correction information
500: Database
510: Past information
G: Generator
F: Factory

What is claimed is:

1. An excess power consumption prediction system comprising:
a database;
a data acquisition unit configured to collect consumption information representing power consumption occurring in a factory, power generation information representing power generation produced by a generator, and weather information, and to store them in the database; and
a controller configured to predict whether a power excess state in which the consumption information exceeds the power generation information occurs through information stored in the database.

2. The excess power consumption prediction system according to claim 1, wherein the controller includes:
a prediction analysis unit configured to generate a prediction result as to whether the power excess state occurs through a machine learning model that extracts and learns one or more of the plurality of pieces of information stored in the database.

3. The excess power consumption prediction system according to claim 2, wherein the machine learning model comprises a CNN (Convolutional Neural Network) model, learns by converting a plurality of pieces of information including the consumption information, the power generation information, and the weather information into a two-dimensional form, and generates the prediction result by analyzing patterns along a time axis.

4. The excess power consumption prediction system according to claim 3, wherein the controller further comprises:
a data processing unit configured to receive a plurality of pieces of information stored in the database and generate preprocessing information in a form suitable for analysis by the CNN model.

5. The excess power consumption prediction system according to claim 2, wherein the prediction analysis unit includes:
a prediction correction unit that includes a verification model for verifying the prediction result generated by the machine learning model and is configured to generate a plurality of comparison values using the verification model and determine reliability of the prediction result.

6. The excess power consumption prediction system according to claim 5, wherein the prediction correction unit, when it is determined that the reliability of the prediction result is lower than a preset level, is configured to change a plurality of the pieces of information used by the machine learning model to generate the prediction result, generate a plurality of correction values, and determine again whether the power excess state occurs using an average of the plurality of correction values generated.

7. The excess power consumption prediction system according to claim 1, wherein the data acquisition unit is configured to additionally acquire:
operation information about a process operation rate of the factory and an operating state of equipment; and
correction information including a number of employees who have come to work and a cleaning state of the generator, and
wherein the controller is configured to pattern the power generation information according to the operation information and the correction information to predict the power excess state.
